(19) United States
(12) Patent Application Publication
(10) Pub. No.: US 2002/0109248 A1
(43) Pub. Date: Aug. 15, 2002

(54) Fast mold manufacturing method with less quantity /more varieties

(76) Inventor: Ying-Chung Chen, Sanchung City (TW)

Correspondence Address: DAVID E. DOUGHERTY, DENNISON,SCHULTZ & DOUGHERTY, 612 CRYSTAL SQUARE 4, 1745 JEFFERSON DAVIS HIGHWAY, ARLINGTON, VA, 22202, US

(21) Appl. No.: 09/782,046

(22) Filed: Feb. 14, 2001

(51) Int. Cl. G06F 19/00; B29B 9/00

(52) U.S. Cl. 264/5; 700/118

(57) ABSTRACT

ABSTRACT OF THE DISCLOSURE Fast mold manufacturing method with less quantity/more varieties, including steps of: taking an alloy block richly containing magnesium, aluminum and zinc as a work piece; converting 3D figure file and writing CNC miller processing program; performing milling and cutting operation to complete basic configuration of the molds up to 90%; sand-spraying the surface of the molds; testing the molds and completing the manufacturing of the molds. Due to the properties of the material, the cutting tool can be operated at high speed and the feeding amount can be greatly increased so that the processing time for respective steps is shortened.

### BACKGROUND OF THE INVENTION

The present invention is related to a fast mold manufacturing method with less quantity/more varieties. This method is particularly applicable to those businesses necessitating less quantity ( the molds have a using life for several hundreds to several thousands of processing ), while more varieties ( the molds are completed in short time). With this method, the manufacturing time is shortened and the cost for the molds can be lowered.

In the conventional mold manufacturing procedure, a 3D figure file drafted by a design engineer is converted into a 2D mold figure. Then a miller processing path program is written with CAD CAM processing path. CNC automatic processing machine serves to perform milling and cutting operation. After completed, the work piece is surface-treated including polishing, sand-spraying, discharge processing, etc. The completed preliminary mold is tested and then partially modified in dimension. It takes about 45 working days to finish all the above steps.

It is a trend to in shortest time commercialize the configuration of a mold designed with a computer. The mold can be then exhibited, catalogued or provide 1:1 real body for a customer to certify or compare. It is required to fastest manufacture the mold designed with a computer, while it is not so important to ask for a using life of the mold which is able to bear several decades of thousands of times of processing. This is because it is an effective strategy of a manufacturer to first gain an order for a great amount of products and then re-manufacture the mold according to standardized procedure, which is able to bear several decades of thousands of times of processing.

Therefore, it is necessary to develop a manufacturing method for fast manufacturing molds in shortest time so as to lower manufacturing cost. Such manufacturing method must meet the requirement of less quantity/more varieties.

### SUMMARY OF THE INVENTION

It is therefore a primary object of the present invention to provide a fast mold manufacturing method with less quantity/more varieties. This method is particularly applicable to those businesses necessitating less quantity, while more varieties. With this method, the manufacturing time is shortened and the cost for the molds can be lowered.

According to the above object, the fast mold manufacturing method with less quantity/more varieties of the present invention takes an alloy block richly containing magnesium, aluminum and zinc as the work piece. The mixing ratios of the respective elements to the alloy are about 60˜90% for magnesium, 7˜37% for aluminum and 3% for zinc. Due to the properties of the material, the chip of the magnesium-rich material is powdered so that the cutting tool can be operated at high speed. Moreover, a milling tool with slenderer diameter can be selected to directly mill the molds. ( The diameter of the tool can be under 0.2 MM.) Therefore, up to90% of the milling/sculpturing of the entire male and female molds can be performed by CNC machine. It is no more necessary to discharge process and manually sculpture the dead comer or dead end of the molds. Accordingly, the time for the most time-consuming mold-sculpturing operation is obviously shortened. As a result, the manufacturing time for the molds is effectively shortened. Relatively, the material cannot bear several decades of thousands of times of high injection impact as the steel molds. However, this meets the requirement of those molds necessitating less quantity ( several hundreds to several thousands ), while more varieties ( shortened time for modifications of molds ). This is particularly applicable to plastic injection and rubber extrusion molds.

The present invention can be best understood through the following description and accompanying drawings wherein:

### BRIEF DESCRIPTION OF THE DRAWINGS

FIG. 1 is a block diagram showing the flow chart of the conventional mold manufacturing procedure; and

FIG. 2 is a block diagram showing the flow chart of the fast mold manufacturing method of the present invention.

### DETAILED DESCRIPTION OF THE PREFERRED EMBODIMENT

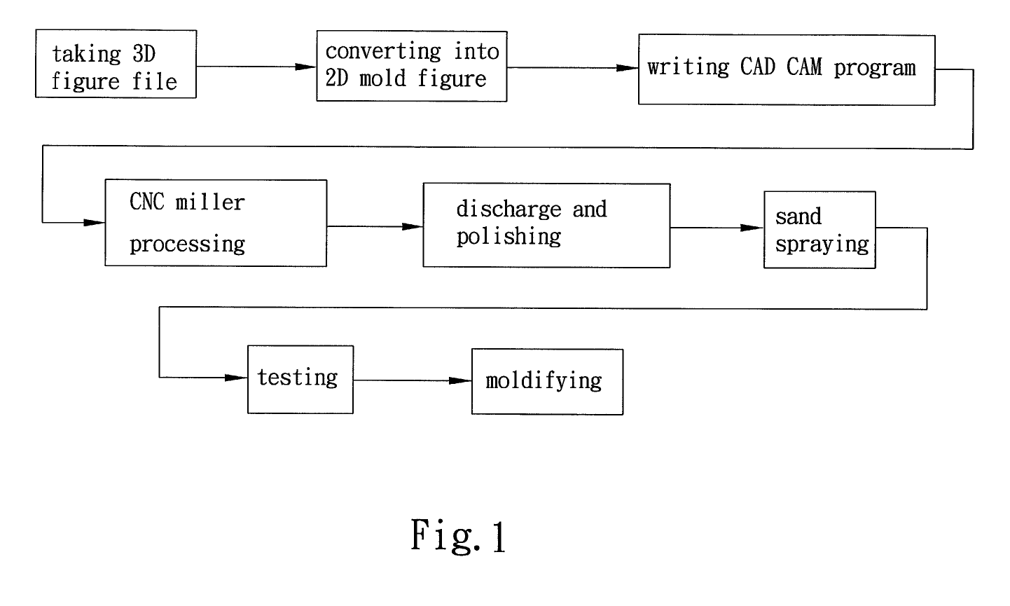

Please refer to FIG. 1 which shows a traditional manufacturing method for molds, including steps of:

a. taking a 3D figure file ( which is generally directly designed and provided by the customer );

b. converting the 3D figure file and drafting a 2D mold figure for processing;

c. drafting CNC miller processing path program and performing milling and cutting operation for male and female molds;

d. manually polishing the male and female molds;

e. sand-spraying the surface of the male and female molds to enhance the precision thereof;

f. testing the molds; and

g. secondarily processing and modifying the molds according to the test result.

The actual processing time for the respective steps of the traditional mold manufacturing method is as follows:

Steps a to b take about 7 working days;

Step c including discharge processing takes about 7 working days;

In step d, it takes about 7 working days for CNC processing of the male mold, about 7 working days for CNC processing of the female mold and about 3 working days for discharge linear cutting; and

Step e including surface treatment and biting processing takes about 10 working days.

After tested, in case it is necessary to modify the molds, the male and female molds must be entirely disassembled and the cutting and surface treatment of the respective components must be repeated once. Such step including assembly and disassembly takes about 7 working days.

Accordingly, the complete processing procedure will take about 45 working days. Such complicated processing procedure and long working day lead to an obstacle to the promotion of the competition.

The above mechanical cutting and manual polishing of the male and female molds in fact are resulted from the material of which the molds are made. The general steel material has a certain extensibility. When processed with a CNC miller, the cutting chip is curled and tends to attach to the tool. Therefore, in order to avoid obtuseness or breakage of the tool due to over-heating, the rotational speed of milling tool and the feeding speed can be hardly increased.

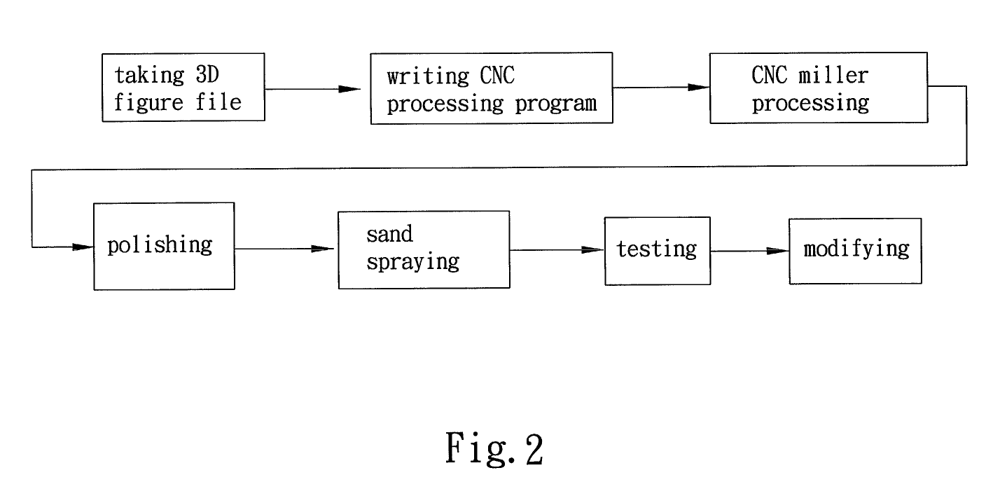

FIG. 2 which shows the manufacturing method for molds according to the present invention, including steps of:

A. taking a 3D figure file and then directly writing CNC miller processing path program, this taking about one working day;

B. performing CNC milling and cutting operation for male and female molds, this taking about 3 working days;

C. polishing the male and female molds, this taking about one working day;

D. sand-spraying the surface of the male and female molds, this taking about 3 hours; and

E. testing the molds, this taking only one working day, including modification and disassembly and assembly of the molds.

In total, it only takes about 7 working days from taking the sample to complete the manufacturing of the molds with less quantity/more varieties. This is meaningful to those businesses necessitating less quantity, while more varieties of modifications of molds.

The present invention takes an alloy block richly containing magnesium, aluminum and zinc as the work piece. The mixing ratios of the respective elements to the alloy are about 60˜90% for magnesium, 7˜37% for aluminum and 3% for zinc. Due to the properties of the material, the chip of the magnesium-rich material is powdered so that the cutting tool can be operated at high speed. Moreover, a milling tool with slenderer diameter can be selected to directly mill the molds. ( The diameter of the tool can be under 0.2 MM.) Therefore, up to 90% of the milling/sculpturing of the entire male and female molds can be performed by CNC machine. Therefore, the secondary 2D mold drawing is avoided. Importantly, during test of the molds, the respective components can be easily modified and processed and it is no more necessary to discharge process and manually sculpture the dead corner or dead end of the molds. Accordingly, the time for the most time-consuming mold-sculpturing operation is obviously shortened. As a result, the manufacturing time for the molds is effectively shortened. Relatively, the material cannot bear several decades of thousands of times of high injection impact as the steel molds. However, this meets the requirement of those molds necessitating less quantity (several hundreds to several thousands), while more varieties (shortened time for modifications of molds). This is particularly applicable to plastic injection and rubber extrusion molds.

In conclusion, with the above less quantity/more varieties mold manufacturing method of the present invention, a manufacturer can first try to make a small quantity of products and then advantageously gain an order of a large amount of products. Then the manufacturer can re-manufacture a steel mold to mass-produce the products. Therefore, the manufacturer can complete the business need at lowest development cost. About 60% of the development cost is saved.

The above embodiment is only used to illustrate the present invention, not intended to limit the scope thereof. Many modifications of the above embodiment can be made without departing from the spirit of the present invention.

What is claimed is:

1. Fast mold manufacturing method with less quantity/more varieties, comprising steps of:
taking an alloy block richly containing magnesium, aluminum and zinc as the work piece, the mixing ratios of the respective elements to the alloy being about 60˜90% for magnesium, 7˜37% for aluminum and 3% for zinc;
converting 3D figure file and writing CNC miller processing program;
performing milling and cutting operation to complete basic configuration of the molds up to 90%;
sand-spraying the surface of the molds;
testing the molds and completing the manufacturing of the molds, whereby due to the properties of the material, the cutting tool can be operated at high speed and the feeding amount can be greatly increased so that the processing time for respective steps is shortened.
